(19) United States
(12) Patent Application Publication
(10) Pub. No.: US 2025/0332582 A1
(43) Pub. Date: Oct. 30, 2025

(54) UNSUPPORTED MEDIUM ENTROPY ALLOY CATALYSTS

(71) Applicant: Saudi Arabian Oil Company, Dhahran (SA)

(72) Inventors: Xiaoxing Wang, Richmond, TX (US); Feng Liang, Houston, TX (US)

(21) Appl. No.: 18/650,606

(22) Filed: Apr. 30, 2024

(51) Int. Cl. B01J 35/00; B01J 35/40; B01J 37/00; C01B 3/26

(52) U.S. Cl. CPC B01J 35/19; B01J 35/40; B01J 37/0036; C01B 3/26; C01B 2203/0277; C01B 2203/0405; C01B 2203/049; C01B 2203/1041; C01B 2203/1241; C01B 2203/1623; C01B 2203/1676

(57) ABSTRACT

Compositions and methods for the catalysis of methane pyrolysis. Compositions include a catalyst that includes a medium entropy alloy particle. Methods include catalyzing the pyrolysis of methane using the catalyst.

### TECHNICAL FIELD

This document relates to catalysts that include a medium entropy metal alloy catalyst, and the catalysis of methane pyrolysis to produce hydrogen gas.

### BACKGROUND

The rapid increase of CO₂ level in the atmosphere is regarded as a primary cause of global climate change. One promising way to address this problem is to switch to clean energy, using a clean fuel such as hydrogen. Currently, hydrogen can be produced using methane steam reforming (MSR), coal gasification, partial oxidation of methane (POM), autothermal reforming of methane (ATR), dry reforming of methane (DRM), and tri-reforming (H₂O, CO₂, and methane). However, all of these processes emit large amounts of CO₂. Alternatively, hydrogen can be produced by catalytic methane pyrolysis (CMP, Eq. 1). CMP can produce CO₂-free and/or low-CO₂ emission hydrogen, as well as valuable solid carbon byproduct such as amorphous carbon, carbon nanotubes, and nanofibers.

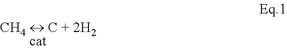

Methane pyrolysis is an endothermic reaction and high temperatures are normally required in the absence of a catalyst. Many different types of catalysts have been developed for methane pyrolysis processes, including metal and carbon-based catalysts. Compared to carbon-based catalysts, metal catalysts are more active and work at a lower temperature, but typically suffer quick deactivation due to metal sintering, carbon encapsulation and metal migration/agglomeration.

### SUMMARY

This disclosure describes catalysts that include a medium entropy metal alloy catalyst, as well as the use of the catalysts to catalyze methane pyrolysis.

In some embodiments, a catalyst system includes a medium entropy alloy (MEA) particle, wherein the MEA particle includes a first principal metal, a second principal metal, and a third principal metal. In some embodiments, the MEA particles include a fourth principal metal (M4). Each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.

In some embodiments, a method of producing a catalyst includes placing a first principal metal, a second principal metal, and a third principal metal, and zirconia media in a ball mill, wherein each of the principal metals is independently selected without repetition from the group consisting Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be. In some embodiments, the method of producing a catalyst includes placing a first principal metal, a second principal metal, a third principal metal, a fourth principal metal, and zirconia media in a ball mill, wherein each of the principal metals is independently selected without repetition from the group consisting Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be. The method includes rotating the ball mill to produce the catalyst; and separating the produced catalyst from the zirconia media.

In some embodiments, a method of catalyzing methane pyrolysis includes loading a catalyst into a reactor, wherein the catalyst includes a medium entropy alloy (MEA) particle, wherein the MEA particle includes a first principal metal, a second principal metal, and a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be. In some embodiments, the method of catalyzing methane pyrolysis includes loading a catalyst into a reactor, wherein the catalyst includes a medium entropy alloy (MEA) particle, wherein the MEA particle includes a first principal metal, a second principal metal, a third principal metal, and a fourth principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be. The method includes purging the reactor with an inert gas, heating the reactor, introducing a feedstock gas and a carrier gas to the reactor, wherein the feedstock gas includes methane and wherein the carrier gas includes an inert gas, and catalyzing the pyrolysis of the methane using the catalyst to produce hydrogen gas and solid carbon.

The details of one or more implementations of the disclosure are set forth in the accompanying drawings and the description that follows. Other features, objects, and advantages of the disclosure will be apparent from the description and drawings, and from the claims.

### DESCRIPTION OF DRAWINGS

FIG. 1A shows an example schematic of an MEA particle of the present disclosure that includes a first principal metal M1, a second principal metal M2, and a third principal metal M3.

FIG. 1B shows an example schematic of an MEA particle of the present disclosure that includes a first principal metal M1, a second principal metal M2, a third principal metal M3, and a fourth principal metal M4.

FIG. 2A shows an example schematic of an MEA particle that includes three principal metals and an oxide.

FIG. 2B shows an example schematic of an MEA particle that includes four principal metals and an oxide.

FIG. 3A shows an example schematic of an MEA particle that includes three principal metals and a metal chloride.

FIG. 3B shows an example schematic of an MEA particle that includes four principal metals and a metal chloride.

FIG. 4A shows an example schematic of an MEA particle of the present disclosure that includes three principal metals, oxides, and metal chloride salts.

FIG. 4B shows an example schematic of an MEA particle that includes four principal metals, oxides, and metal chloride salts.

FIG. 5 is a flow chart of an example method of producing a catalyst of the present disclosure by ball milling.

FIG. 6 shows an example schematic of a fixed-bed flow reactor system.

FIG. 7 is a flow chart of an example method of producing hydrogen and a solid carbon byproduct.

Like reference symbols in the various drawings indicate like elements.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Provided in this disclosure are catalysts that include medium entropy alloys (MEAs), the synthesis of the catalysts, and the use of the catalysts for effective zero-and/or low-CO₂ hydrogen production via methane pyrolysis. The hydrogen can be produced from the methane present in natural gas at elevated temperatures, thus providing an efficient utilization of natural gas in a sustainable way.

Medium entropy metal alloys include three or four principal metals. These alloys have unique properties caused by the effects including thermodynamic effect (high entropy), structural effect (crystal lattice distortion), kinetics effect (sluggish diffusion) and cocktail composition effect. Compared to conventional metal alloys, those special effects can significantly influence their catalytic performance for methane pyrolysis, which could reduce the reaction temperature, improve the activity, promote resistant to carbon deactivation and metal sintering/agglomeration, thus benefit the hydrogen production.

MEAs have a configuration entropy between 1R and 1.5R. Configuration entropy can be calculated with the relationship

$$S = - R {\sum }_{i = 1}^{n} {x}_{{M}_{i}} ln ( {x}_{{M}_{i}} ) ,$$

where S is entropy, R is the gas constant, n is the type number of the constitute atoms, and x_{M}_{ᵢ} is the mole fraction of the composition of atom Mᵢ. MEAs typically have near equimolar and non-equimolar alloys of three or four principal elements.

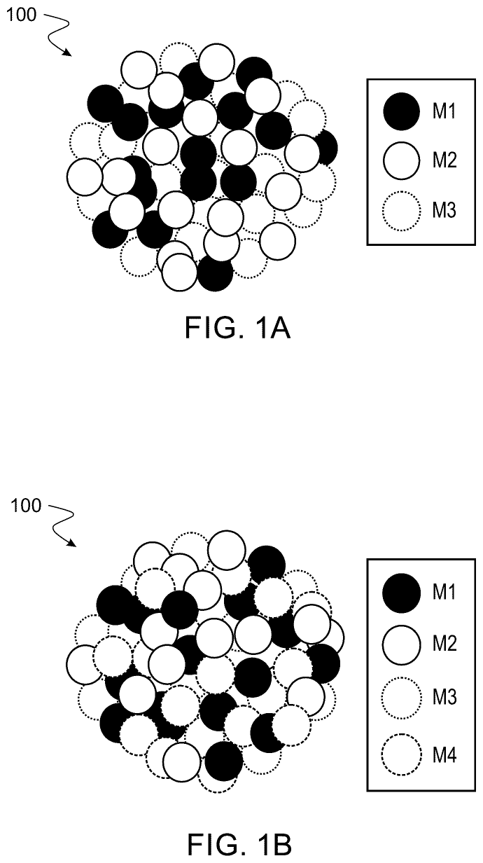

The catalysts described herein include one or more MEA particles. The MEA particles include three or four principal metals. As described herein, MEA particles that include three or four principal metals show improved performance in catalytic methane pyrolysis. For example, an MEA particle that includes three or four principal metals can have a higher initial and a higher overall methane conversion rate. The MEA particles of the present disclosure include a first principal metal (M1), a second principal metal (M2), and a third principal metal (M3). In some embodiments, the MEA particles include a fourth principal metal (M4). The principal metals can be independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be. None of M1, M2, or M3 are the same metal. For example, the MEA particles with three principal metals can be FeMnCo, FeMnNi, FeMnMo, FeMnCu, FeMoCo, FeMoNi, FeMoCu, MnCoNi, MnCoCu, MnCoMo, MnNiCu, MnNiMo, MoCoNi, FeCoCu, FeNiCu, MoCoCu, MoNiCu, or CoNiCu. FIG. 1A shows an example schematic of an MEA particle 100 of the present disclosure. The MEA particle A00 includes a first principal metal M1, a second principal metal M2, and a third principal metal M3. FIG. 1B shows an example schematic of an MEA particle 100 of the present disclosure that includes a first principal metal M1, a second principal metal M2, a third principal metal M3, and a fourth principal metal M4. Here again, none of M1, M2, M3, or M4 are the same metal. For example, the MEA particles with four principal metals can be FeMnCoNi, FeMnCoCu, FeMnCoMo, FeMnNiMo, FeMnNiCu, FeMnMoCu, FeCoNiMo, FeCoNiCu, FeCoCuMo, CoNiCuMn, CoNiCuMo, MnMoCoNi, MnMoCoCu, or MnMoNiCu.

The content of each principal metal can vary from 1 atomic percent (at %) to 90 at %. In some embodiments, the amount of each principal metal in the MEA particle can vary from about 1 at % to about 80 at %, from about 1 at % to about 70 at %, from about 1 at % to about 60 at %, from about 1 at % to about 50 at %, from about 1 at % to about 40 at %, from about 1 at % to about 30 at %, from about 1 at % to about 20 at %, from about 1 at % to about 10 at %. In some embodiments, the amount of each principal metal in the MEA particle can vary from about 10 at % to about 80 at %, from about 10 at % to about 70 at %, from about 10 at % to about 60 at %, from about 10 at % to about 50 at %, from about 10 at % to about 40 at %, from about 10 at % to about 30 at %, or from about 10 at % to about 20 at %.

In some embodiments, each of the principal metals is present in an approximately equimolar amount. In some embodiments, the ratio of M1:M2:M3 is 1:1:1. In some embodiments, the ratio of M1:M2:M3:M4 is 1:1:1:1.

In some embodiments, the atomic percentage of one principal metal element is higher than the other principal metal elements in the MEA particle. For example, the atomic percentage of one of the principal metal elements is more than 30 atomic % (at %), more than 35%, more than 40 at %, more than 45 at %, more than 50 at %, more than 55 at %, or more than 60 at %.

In some embodiments, an MEA particle includes a first principal metal, where the first principal metal is Fe, a second principal metal, where the second principal metal is Mn, and a third principal metal, where the third principal metal is selected from the group consisting of: Co, Cr, Ni, Al, Cu, Zn, Ti, Zr, Mo, V, Ru, Rh, Pd, Ag, W, Re, Ir, Pt, Au, Ce, Y, Yb, Sn, Ga, In, and Be. In some embodiments, an MEA particle includes a first principal metal, where the first principal metal is Fe, a second principal metal, where the second principal metal is Mn, and a third principal metal, where the third principal metal is a transition metal selected from the group consisting of Co, Cr, Ni, Cu, Zn, Ti, Zr, Mo, V, Ru, Rh, Pd, Ag, W, Re, Ir, Pt, Au, Y, and Sn. In some embodiments, an MEA particle includes a first principal metal, where the first principal metal is Fe, a second principal metal, where the second principal metal is Mn, and a third principal metal, where the third principal metal is an alkaline earth metal, Be. In some embodiments, an MEA particle includes a first principal metal, where the first principal metal is Fe, a second principal metal, where the second principal metal is Mn, and a third principal metal, where the third principal metal is a lanthanide selected from the group consisting of Ce and Yb. In some embodiments, an MEA particle includes a first principal metal, where the first principal metal is Fe, a second principal metal, where the second principal metal is Mn, and a third principal metal, where the third principal metal is selected from the group consisting of Al, Ga and In. In some embodiments, an MEA particle with three principal metals includes a first principal metal, where the first principal metal is Fe, a second principal metal, where the second principal metal is Mn, and a third principal metal, where the third principal metal is Ni. In some embodiments, an MEA particle includes Fe, Mn, and Ni in a 1:1:1 atomic ratio.

In some embodiments, an MEA particle includes a first principal metal, where the first principal metal is Fe, a second principal metal, where the second principal metal is Ni, and a third principal metal, where the third principal metal is selected from the group consisting of: Co, Cr, Mn, Al, Cu, Zn, Ti, Zr, Mo, V, Ru, Rh, Pd, Ag, W, Re, Ir, Pt, Au, Ce, Y, Yb, Sn, Ga, In, and Be. In some embodiments, an MEA particle includes a first principal metal, where the first principal metal is Fe, a second principal metal, where the second principal metal is Ni, and a third principal metal, where the third principal metal is a transition metal selected from the group consisting of Co, Cr, Mn, Cu, Zn, Ti, Zr, Mo, V, Ru, Rh, Pd, Ag, W, Re, Ir, Pt, Au, Y, and Sn. In some embodiments, an MEA particle includes a first principal metal, where the first principal metal is Fe, a second principal metal, where the second principal metal is Ni, and a third principal metal, where the third principal metal is an alkaline earth metal, Be. In some embodiments, an MEA particle includes a first principal metal, where the first principal metal is Fe, a second principal metal, where the second principal metal is Ni, and a third principal metal, where the third principal metal is a lanthanide selected from the group consisting of Ce and Yb. In some embodiments, an MEA particle includes a first principal metal, where the first principal metal is Fe, a second principal metal, where the second principal metal is Ni, and a third principal metal, where the third principal metal is selected from the group of consisting of Al, Ga and In.

In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is selected from the group consisting of: Co, Cr, Al, Cu, Zn, Ti, Zr, Mo, V, Ru, Rh, Pd, Ag, W, Re, Ir, Pt, Au, Ce, Y, Yb, Sn, Ga, In, and Be. In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is a transition metal selected from the group consisting of Co, Cr, Cu, Zn, Ti, Zr, Mo, V, Ru, Rh, Pd, Ag, W, Re, Ir, Pt, Au, Y, and Sn. In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is an alkaline earth metal, Be. In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is a lanthanide selected from the group consisting of Ce and Yb. In some embodiments, an MEA particle includes a first principal metal, where the first principal metal is Fe, a second principal metal, where the second principal metal is Mn, a third principal metal, where the third principal metal is Ni, and a fourth principal metal, where the fourth principal metal is Al. In some embodiments, an MEA particle with four principal metals includes a first principal metal, where the first principal metal is Fe, a second principal metal, where the second principal metal is Mn, a third principal metal, where the third principal metal is Ni, and a fourth principal metal, where the fourth principal metal is Co. In some embodiments, the MEA particle includes Fe, Mn, Ni, and Co in a 1:1:1:1 atomic ratio.

In some embodiments, the MEA particles have a configuration entropy between 1R and 1.5R, where R is the gas constant.

Table 1 lists the first (M1), second (M2), and third (M3) principal metals of example MEA particles that include three principal metals. In some embodiments, the ratio of the principal metals in the MEA particles listed in Table 1 is 1:1:1. Table 2 lists the first (M1), second (M2), third (M3), and fourth (M4) principal metals of example MEA particles that include four principal metals. In some embodiments, the ratio of the principal metals in the MEA particles listed in Table 2 is 1:1:1:1. Tables 1 and 2 are not limiting, and other non-repetitive combinations of the principal metals are possible.

TABLE 1
Principal Metals of Example MEA particles

| M1 | M2 | M3 |
|---|---|---|
| Co | Ni | Cu |
| Fe | Co | Cu |
| Fe | Mn | Be |
| Fe | Mn | Ca |
| Fe | Mn | Ce |
| Fe | Mn | Yb |
| Fe | Mn | Al |
| Fe | Mn | Ag |
| Fe | Mn | Au |
| Fe | Mn | Co |
| Fe | Mn | Cr |
| Fe | Mn | Cu |
| Fe | Mn | Ir |
| Fe | Mn | Mo |
| Fe | Mn | Ni |
| Fe | Mn | Pd |
| Fe | Mn | Pt |
| Fe | Mn | Re |
| Fe | Mn | Rh |
| Fe | Mn | Ru |
| Fe | Mn | Sn |
| Fe | Mn | W |
| Fe | Mn | Zn |
| Fe | Mn | Zr |
| Fe | Mo | Co |
| Fe | Mo | Cu |
| Fe | Mo | Ni |
| Fe | Ni | Be |
| Fe | Ni | Ca |
| Fe | Ni | Ce |
| Fe | Ni | Yb |
| Fe | Ni | Al |
| Fe | Ni | Ag |
| Fe | Ni | Au |
| Fe | Ni | Co |
| Fe | Ni | Cr |
| Fe | Ni | Cu |
| Fe | Ni | Ir |
| Fe | Ni | Mn |
| Fe | Ni | Pd |
| Fe | Ni | Pd |
| Fe | Ni | Pt |
| Fe | Ni | Re |
| Fe | Ni | Rh |
| Fe | Ni | Ru |
| Fe | Ni | Sn |
| Fe | Ni | W |
| Fe | Ni | Zn |
| Fe | Ni | Zr |
| Mn | Co | Cu |
| Mn | Co | Mo |
| Mn | Co | Ni |
| Mn | Ni | Cu |
| Mn | Ni | Mo |
| Mo | Co | Cu |
| Mo | Ni | Cu |

TABLE 2
Principal Metals of Example MEA particles

| M1 | M2 | M3 | M4 |
|---|---|---|---|
| Co | Ni | Cu | Mn |
| Co | Ni | Cu | Mo |
| Fe | Co | Cu | Mo |
| Fe | Co | Ni | Cu |
| Fe | Co | Ni | Mo |
| Fe | Mn | Ni | Ca |
| Fe | Mn | Ni | Be |
| Fe | Mn | Ni | Ce |
| Fe | Mn | Ni | Yb |
| Fe | Mn | Ni | Al |
| Fe | Mn | Ni | Co |
| Fe | Mn | Ni | Cr |
| Fe | Mn | Ni | Cu |
| Fe | Mn | Ni | Zn |
| Fe | Mn | Ni | Zr |
| Fe | Mn | Ni | Ru |
| Fe | Mn | Ni | Rh |
| Fe | Mn | Ni | Pd |
| Fe | Mn | Ni | Ag |
| Fe | Mn | Ni | W |
| Fe | Mn | Ni | Re |
| Fe | Mn | Ni | Ir |
| Fe | Mn | Ni | Pt |
| Fe | Mn | Ni | Au |
| Fe | Mn | Ni | Sn |
| Fe | Mn | Ni | Mo |
| Fe | Mn | Co | Cu |
| Fe | Mn | Co | Mo |
| Fe | Mn | Mo | Cu |
| Mn | Mo | Co | Cu |
| Mn | Mo | Co | Ni |
| Mn | Mo | Ni | Cu |

The size of the MEA particle can vary from a few nanometers to micrometers in diameter. For example, the MEA particle can be from about 1 nm to about 10 μm in diameter or about 1 nm to about 1 μm in diameter. In some embodiments, the MEA particle can be from about 1 nm to about 1 μm in diameter, about 1 nm to about 900 nm, about 1 nm to about 800 nm, about 1 nm to about 700 nm, about 1 nm to about 600 nm, about 1 nm to about 500 nm, about 1 nm to about 400 nm, about 1 nm to about 300 nm, about 1 nm to about 200 nm, about 1 nm to about 100 nm, about 1 nm to about 90 nm, about 1 nm to about 80 nm, about 1 nm to about 70 nm, about 1 nm to about 60 nm, about 1 nm to about 50 nm, about 1 nm to about 40 nm, about 1 nm to about 30 nm, about 1 nm to about 20 nm, about 1 nm to about 10 nm, about 1 nm to about 5 nm, or about 1 nm to about 3 nm in diameter. In some embodiments, the MEA particle can be from about 1 μm to about 10 μm, about 1 μm to about 9 μm, about 1 μm to about 8 μm, about 1 μm to about 7 μm, about 1 μm to about 6 μm, about 1 μm to about 5 μm, about 1 μm to about 4 μm, about 1 μm to about 3 μm, or about 1 μm to about 2 μm in diameter. The shape of the MEA particles can be spherical, square/cubic, triangle, or irregular.

In some embodiments, the MEA particle includes a promoter. The inclusion of a promoter can change the chemical, physical, and structural properties of the catalyst. The promoters can include a chemical promoter, a structural promoter, or any combination thereof. Chemical promoters change the distribution of electrons in the catalyst and thus improve the activity of the catalyst. Structural promoters alter the structure and physical properties of the catalyst. In addition, structural promoters improve the mechanics and sintering resistance of the catalyst. Further, structural promoters alter the adsorption and chemisorption ability of the active sites for the reactants and products, thus improving the selectivity of the catalyst and enhancing the efficiency and rate of reactions. Suitable promoters include small amounts of molybdenum, calcium, cesium, high melting oxides of some metals (for example, In₂O₃, Cr₂O₃), and rare earth metals. In some embodiments, the MEA particle can include about 0.5 at % to about 10 at % promoter. For example, the MEA particle can include about 0.5 at % to about 9 at %, about 0.5 at % to about 8 at %, about 0.5 at % to about 7 at %, about 0.5 at % to about 6 at %, about 0.5 at % to about 5 at %, about 0.5 at % to about 4 at %, about 0.5 at % to about 3 at %, about 0.5 at % to about 2 at %, about 0.5 at % to about 1 at % promoter, about 1 at % to about 10 at %, about 2 at % to about 10 at %, about 3 at % to about 10 at %, about 4 at % to about 10 at %, about 5 at % to about 10 at %, about 6 at % to about 10 at %, about 7 at % to about 10 at %, about 8 at % to about 10 at %, or about 9 at % to about 10 at %.

The promoters increase the activity of iron-based catalysts. All of the MEA particles described herein, for example, those listed in Table 1 and Table 2, can include a promoter as described herein.

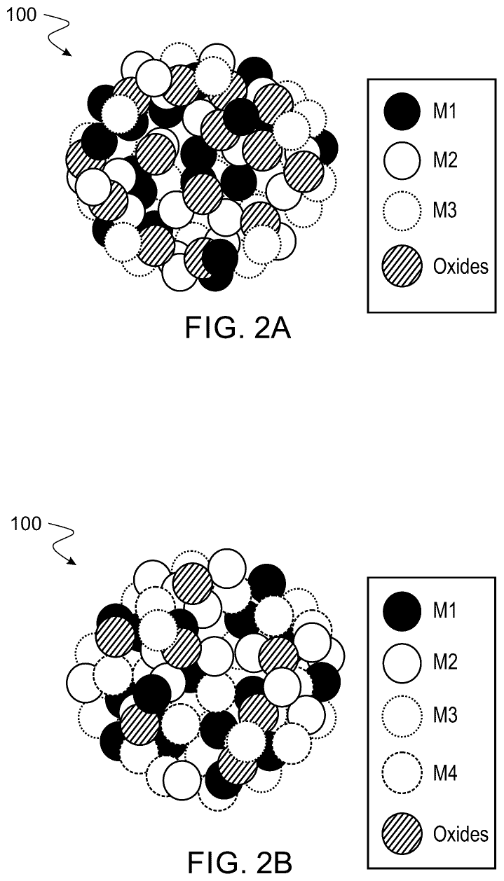

In some embodiments, a non-reducible metal oxide is added to the MEA particles and functions as a promoter. FIG. 2A shows an example schematic of an MEA particle 100 that includes three principal metals and an oxide. FIG. 2B shows an example schematic of an MEA particle 100 that includes four principal metals an oxide. The oxide can provide additional surface area and change the interaction between metals, and therefore plays an important role in the catalytic process. The oxide promoter can improve the sintering resistance of alloys, facilitate the adsorption of reactants, and change the carbon growth mechanism. Accordingly, a promoter can improve the activity and stability of an MEA particle in catalytic hydrogen production.

The non-reducible oxide promoter can include Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, or lanthanide oxides (e.g., La₂O₃, Er₂O₃), or any combination thereof. In some embodiments, the atomic percentage of non-reducible oxides in the MEA particle is from more than 0 at % to about 20 at %, for example from more than 0 at % to about 20 at %, more than 0 at % to about 19 at %, more than 0 at % to about 18 at %, more than 0 at % to about 17 at %, more than 0 at % to about 17 at %, more than 0 at % to about 16 at %, more than 0 at % to about 15 at %, more than 0 at % to about 14 at %, more than 0 at % to about 13 at %, more than 0 at % to about 12 at %, more than 0 at % to about 11 at %, more than 0 at % to about 10 at %, more than 0 at % to about 9 at %, more than 0 at % to about 8 at %, more than 0 at % to about 7 at %, more than 0 at % to about 6 at %, more than 0 at % to about 5 at %, more than 0 at % to about 4 at %, more than 0 at % to about 3 at %, more than 0 at % to about 2 at %, more than 0 at % to about 1 at %, more than 0 at % to about 0.5 at %, more than 0 at % to about 0.2 at %, about 0.1 at % to about 20 at %, about 0.1 at % to about 19 at %, about 0.1 at % to about 18 at %, about 0.1 at % to about 17 at %, about 0.1 at % to about 17 at %, about 0.1 at % to about 16 at %, about 0.1 at % to about 15 at %, about 0.1 at % to about 14 at %, about 0.1 at % to about 13 at %, about 0.1 at % to about 12 at %, about 0.1 at % to about 11 at %, about 0.1 at % to about 10 at %, about 0.1 at % to about 9 at %, about 0.1 at % to about 8 at %, about 0.1 at % to about 7 at %, about 0.1 at % to about 6 at %, about 0.1 at % to about 5 at %, about 0.1 at % to about 4 at %, about 0.1 at % to about 3 at %, about 0.1 at % to about 2 at %, about 0.1 at % to about 1 at %, about 0.1 at % to about 0.5 at %, about 0.1 at % to about 0.2 at %, about 0.1% to about 20%, about 1 at % to about 20 at %, about 2 at % to about 20 at %, about 3 at % to about 20 at %, about 4 at % to about 20 at %, about 5 at % to about 20 at %, about 6 at % to about 20 at %, about 7 at % to about 20 at %, about 8 at % to about 20 at %, about 9 at % to about 20 at %, about 10 at % to about 20 at %, about 11 at % to about 20 at %, about 11 at % to about 20 at %, about 12 at % to about 20 at %, about 13 at % to about 20 at %, about 14 at % to about 20 at %, about 15 at % to about 20 at %, about 16 at % to about 20 at %, about 17 at % to about 20 at %, about 18 at % to about 20 at %, or about 19 at % to about 20 at %. In some embodiments, the atomic percentage of non-reducible oxides in the MEA particle is less than 20 at %, for example less than 19 at %, less than 18 at %, less than 17 at %, less than 16 at %, less than 15 at %, less than 14 at %, less than 13 at %, less than 12 at %, less than 11 at %, less than 10 at %, less than 9 at %, less than 8 at %, less than 7 at %, less than 6 at %, less than 5 at %, less than 4 at %, less than 3 at %, less than 2 at %, or less than 1 at %.

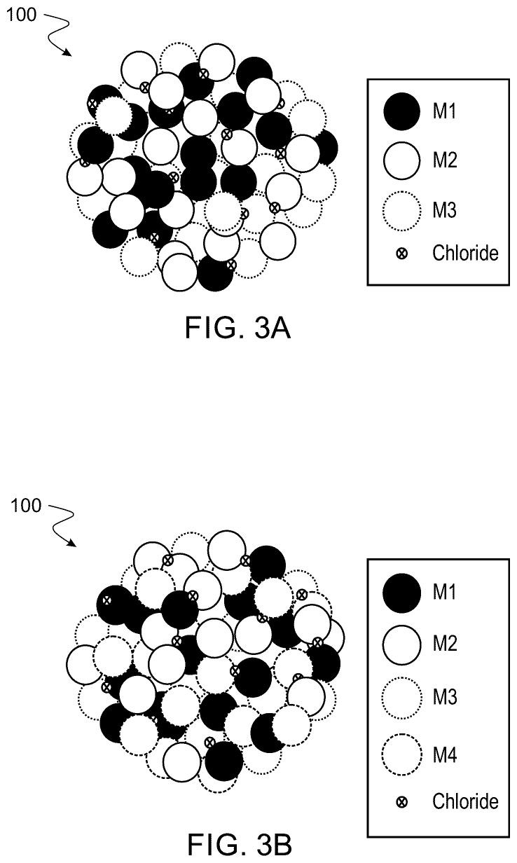

In some embodiments, a metal chloride can be incorporated as a promoter into the MEA particles. At high temperatures, the metal chlorides can activate methane molecules, generating more CH₃ radicals for fast pyrolysis. All of the MEA particles described herein, for example, those listed in Table 1 and Table 2, can include metal chloride salts as described herein. FIG. 3A shows an example schematic of an MEA particle 100 that includes three principal metals and a metal chloride. FIG. 3B shows an example schematic of an MEA particle 100 that includes four principal metals and a metal chloride. The metal chlorides can include chlorides of alkali metals, i.e., chlorides of Li, Na, Ca, K, Cs, or Fr, or chlorides of Fe, Co, Mn, Mg, Al, Ni, Mo, Cu, Pd, Pt, Ce, Mg, La, Nd, Ge, or Re, or any combination thereof. For example, the metal chloride can be LiCI, NaCl, KCl, CsCl, FrCl₂, FeCl₃, CoCl₂, CoCl₃, MnCl₂, MnCl₃, MgCl₂, AlCl₃, NiCl₂, MoCl₂, MoCl₃, MoCl₄, MoCl₅, MoCl₆, CuCl, CuCl₂, PdCl₂, PtCl₂, CeCl₃, MgCl₂, LaCl₃, NdCl₃, GeCl₄, ReCl₄, ReCl₅, or ReCl₆, or any combination thereof. In some embodiments, the atomic percentage of the metal chlorides is more than 0 at % to about 20 at %, for example from more than 0 at % to about 20 at %, more than 0 at % to about 19 at %, more than 0 at % to about 18 at %, more than 0 at % to about 17 at %, more than 0 at % to about 17 at %, more than 0 at % to about 16 at %, more than 0 at % to about 15 at %, more than 0 at % to about 14 at %, more than 0 at % to about 13 at %, more than 0 at % to about 12 at %, more than 0 at % to about 11 at %, more than 0 at % to about 10 at %, more than 0 at % to about 9 at %, more than 0 at % to about 8 at %, more than 0 at % to about 7 at %, more than 0 at % to about 6 at %, more than 0 at % to about 5 at %, more than 0 at % to about 4 at %, more than 0 at % to about 3 at %, more than 0 at % to about 2 at %, more than 0 at % to about 1 at %, more than 0 at % to about 0.5 at %, more than 0 at % to about 0.2 at %, about 0.1 at % to about 20 at %, about 0.1 at % to about 19 at %, about 0.1 at % to about 18 at %, about 0.1 at % to about 17 at %, about 0.1 at % to about 17 at %, about 0.1 at % to about 16 at %, about 0.1 at % to about 15 at %, about 0.1 at % to about 14 at %, about 0.1 at % to about 13 at %, about 0.1 at % to about 12 at %, about 0.1 at % to about 11 at %, about 0.1 at % to about 10 at %, about 0.1 at % to about 9 at %, about 0.1 at % to about 8 at %, about 0.1 at % to about 7 at %, about 0.1 at % to about 6 at %, about 0.1 at % to about 5 at %, about 0.1 at % to about 4 at %, about 0.1 at % to about 3 at %, about 0.1 at % to about 2 at %, about 0.1 at % to about 1 at %, about 0.1 at % to about 0.5 at %, about 0.1 at % to about 0.2 at %, about 0.1% to about 20%, about 1 at % to about 20 at %, about 2 at % to about 20 at %, about 3 at % to about 20 at %, about 4 at % to about 20 at %, about 5 at % to about 20 at %, about 6 at % to about 20 at %, about 7 at % to about 20 at %, about 8 at % to about 20 at %, about 9 at % to about 20 at %, about 10 at % to about 20 at %, about 11 at % to about 20 at %, about 11 at % to about 20 at %, about 12 at % to about 20 at %, about 13 at % to about 20 at %, about 14 at % to about 20 at %, about 15 at % to about 20 at %, about 16 at % to about 20 at %, about 17 at % to about 20 at %, about 18 at % to about 20 at %, or about 19 at % to about 20 at %. In some embodiments, the atomic percentage of metal chlorides in the MEA particle is less than 20 at %, for example less than 19 at %, less than 18 at %, less than 17 at %, less than 16 at %, less than 15 at %, less than 14 at %, less than 13 at %, less than 12 at %, less than 11 at %, less than 10 at %, less than 9 at %, less than 8 at %, less than 7 at %, less than 6 at %, less than 5 at %, less than 4 at %, less than 3 at %, less than 2 at %, or less than 1 at %.

In some embodiments, other compounds which are non-reducible and stable at high temperatures (i.e., stable between 500° C. and 900° C.) can be incorporated as a promoter into the MEA particles described herein. All of the MEA particles described herein, for example the MEA particles listed in Table 1 and Table 2, can include non-reducible and high-temperature-stable compounds as described herein. The non-reducible, stable compounds include carbides, borides, boron carbides, nitrides, boron nitrides, silicide, aluminides, phosphides, phosphates, sulfides, sulfates, hydrides, carbonitrides, (for example, Fe₃C, KBr, NaNO₃, B₄C, BN, Na₄Si₄, Na₂Al₂O₄, FeP, Na₃PO₄, FeS, Na₂SO₄, MgH, or C₃N₄) graphene, graphene oxide, carbon nanotubes, graphite, and any combinations thereof. In some embodiments, the atomic percentage of non-reducible and high-temperature-stable compound promoter is more than 0 at % to about 20 at %, for example from more than 0 at % to about 20 at %, more than 0 at % to about 19 at %, more than 0 at % to about 18 at %, more than 0 at % to about 17 at %, more than 0 at % to about 17 at %, more than 0 at % to about 16 at %, more than 0 at % to about 15 at %, more than 0 at % to about 14 at %, more than 0 at % to about 13 at %, more than 0 at % to about 12at %, more than 0 at % to about 11 at %, more than 0 at % to about 10 at %, more than 0 at % to about 9 at %, more than 0 at % to about 8 at %, more than 0 at % to about 7 at %, more than 0 at % to about 6 at %, more than 0 at % to about 5 at %, more than 0 at % to about 4 at %, more than 0 at % to about 3 at %, more than 0 at % to about 2 at %, more than 0 at % to about 1 at %, more than 0 at % to about 0.5 at %, more than 0 at % to about 0.2 at %, about 0.1 at % to about 20 at %, about 0.1 at % to about 19 at %, about 0.1 at % to about 18 at %, about 0.1 at % to about 17 at %, about 0.1 at % to about 17 at %, about 0.1 at % to about 16 at %, about 0.1 at % to about 15 at %, about 0.1 at % to about 14 at %, about 0.1 at % to about 13 at %, about 0.1 at % to about 12 at %, about 0.1 at % to about 11 at %, about 0.1 at % to about 10 at %, about 0.1 at % to about 9 at %, about 0.1 at % to about 8 at %, about 0.1 at % to about 7 at %, about 0.1 at % to about 6 at %, about 0.1 at % to about 5 at %, about 0.1 at % to about 4 at %, about 0.1 at % to about 3 at %, about 0.1 at % to about 2 at %, about 0.1 at % to about 1 at %, about 0.1 at % to about 0.5 at %, about 0.1 at % to about 0.2 at %, about 0.1% to about 20%, about 1 at % to about 20 at %, about 2 at % to about 20 at %, about 3 at % to about 20 at %, about 4 at % to about 20 at %, about 5 at % to about 20 at %, about 6 at % to about 20 at %, about 7 at % to about 20 at %, about 8 at % to about 20 at %, about 9 at % to about 20 at %, about 10 at % to about 20 at %, about 11 at % to about 20 at %, about 11 at % to about 20 at %, about 12 at % to about 20 at %, about 13 at % to about 20 at %, about 14 at % to about 20 at %, about 15 at % to about 20 at %, about 16 at % to about 20 at %, about 17 at % to about 20 at %, about 18 at % to about 20 at %, or about 19 at % to about 20 at %. In some embodiments, the atomic percentage of non-reducible and high-temperature-stable compound promoter in the MEA particle is less than 20 at %, for example less than 19 at %, less than 18 at %, less than 17 at %, less than 16 at %, less than 15 at %, less than 14 at %, less than 13 at %, less than 12 at %, less than 11 at %, less than 10 at %, less than 9 at %, less than 8 at %, less than 7 at %, less than 6 at %, less than 5 at %, less than 4 at %, less than 3 at %, less than 2 at %, or less than 1 at %.

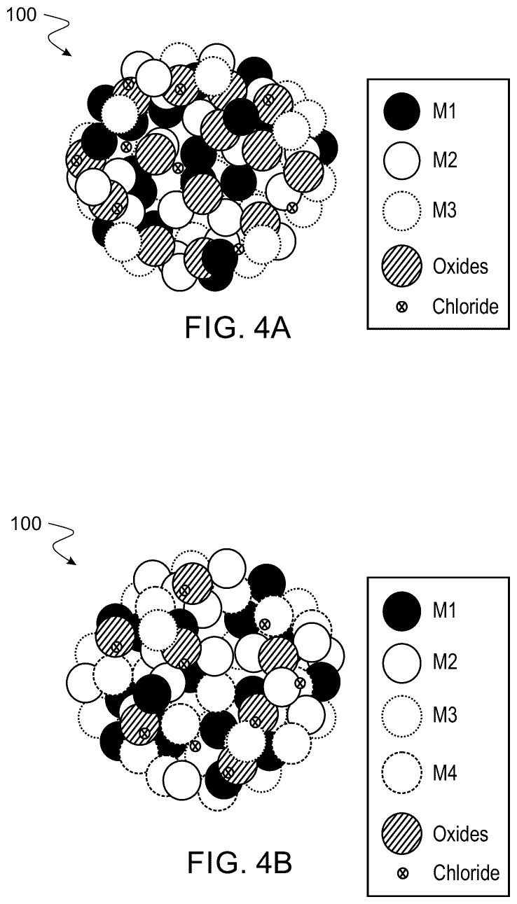

In some embodiments, the MEA particles described herein can include non-reducible oxides, metal chloride salts, and/or other non-reducible and high-temperature-stable compounds. FIG. 4A shows an example schematic of an MEA particle 100 of the present disclosure that includes three principal metals, oxides, and metal chloride salts, as described herein. FIG. 4B shows an example schematic of an MEA particle that includes four principal metals, oxides, and metal chloride salts. All of the MEA particles described herein, for example the MEA particles listed in Table 1 and Table 2, can include non-reducible oxides, metal chloride salts, and/or other non-reducible and high-temperature stable compounds as described herein.

### Synthesis and Characterization of Catalysts including MEA Particles

The MEA particles can be synthesized using wet-chemical methods, for example, impregnation, co-precipitation, solvothermal, or ultrasonicated-assisted wet-chemistry. The MEA particles can by synthesized using sol-gel auto-combustion method, spray pyrolysis, carbothermal shock synthesis, hydrothermal method, pulse-laser ablation, mechanical milling, mechanical alloying, arc melting, induction melting, metal spray technique, molecular beam epitaxy (MBE), atomic layer deposition (ALD), chemical vapor deposition (CVD), or pulsed laser deposition (PLD).

The MEA particles can be synthesized by mechanical mill, for example, ball milling. In a ball milling procedure, an amount of the three principal metals, and optionally a fourth principal metal, are placed in a ball mill along with zirconia media. The zirconia media includes zirconia particles with a diameter between 0.5 and 10 mm. For example, the zirconia media can include particles with a diameter of 1 mm, or 3 mm. In some embodiments, the ball milling process utilizes more than one size of zirconia media, for example 1 mm and 3 mm media. The ball mill is then rotated at room temperature for a period of time sufficient to produce the catalyst. For example, the ball mill can be rotated for 1-5 days. In some embodiments, the ball mill is rotated for 2 days. The ball mill is rotated at a speed of about 500 to about 2000 rpm, for example, about 1100 rpm. The resulting MEA powder is then separated from the zirconia media and collected. In some embodiments, the powder is separated from the zirconia media by filtering through a fine mesh screen or a mesh sieve.

In some embodiments, the MEA particles can include a non-reducible metal oxide. To synthesize MEA particles that include a non-reducible metal oxide, the non-reducible metal oxide is placed in the ball mill along with the zirconia media, the three principal metals, and optionally the fourth principal metal, as described herein. The ball mill is then rotated at room temperature for a period of time sufficient to produce the catalyst as described herein. In some embodiments, the MEA particles can include a metal chloride. To synthesize MEA particles that include a metal chloride, the metal chloride is placed in the ball mill along with the zirconia media, the three principal metals, and optionally the fourth principal metal, as described herein. The ball mill is then rotated at room temperature for a period of time sufficient to produce the catalyst as described herein.

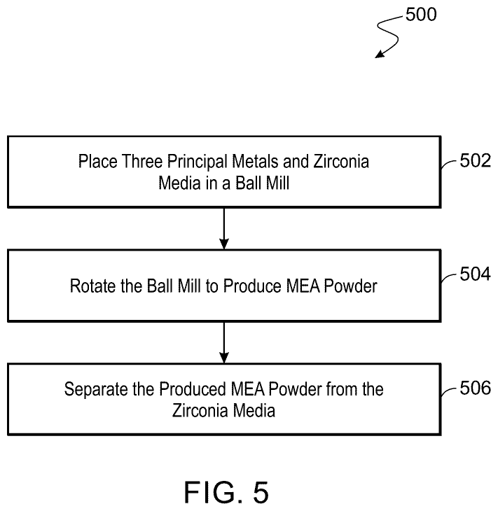

FIG. 5 is a flow chart of an example method 500 of producing a catalyst of the present disclosure by ball milling. At 502, three principal metals and zirconia media are placed in a ball mill. In some embodiments, a fourth principal metal is placed in a ball mill. At 504, the ball mill is rotated to produce MEA powder. At 506, the produced MEA powder is separated from the zirconia media and collected.

The chemical and physical properties of the synthesized catalysts can be investigated with various characterization techniques including X-ray diffraction (XRD), X-ray photoelectron spectroscopy (XPS), scanning electron microscopy (SEM), high-resolution transmission electron microscopy (HRTEM), atomic force microscopy (AFM), energy-dispersive X-ray spectrometry (EDX), BET-surface area, inductively coupled plasma mass spectrometry (ICP-MS), X-ray absorption coefficient, Fourier-transform infrared spectroscopy (FTIR), dynamic light scattering (DLS), UV-vis spectrometry, photoluminescence spectroscopy. In addition, mechanical properties can be analyzed by nanoindentation and dynamical mechanical analysis (e.g., hardness, modulus).

### Catalytic Performance of MEA Catalysts for Hydrogen Production

The evaluation of the catalytic performance of the prepared MEA catalysts for hydrogen production from catalyzed methane pyrolysis can be carried out in a fixed-bed flow reactor at atmospheric pressure. The fixed-bed flow reactor includes a reactor with a catalyst bed. The reactor is in fluid communication with a feedstock gas source and a carrier gas source via a transfer line. The system includes a carrier gas valve that can control the amount and/or the rate at which the carrier gas introduced into the system. The system includes a feedstock gas valve that can control the amount and/or the rate at which the feedstock gas is introduced into the system. In some embodiments, the feedstock gas is natural gas that includes methane. In some embodiments, the feedstock gas is methane gas. In some embodiments, the carrier gas is N₂ or Ar. The carrier gas source and the feedstock gas source are both fluidly connected via the carrier gas valve and the feedstock gas valve to the transfer line. The transfer line is in fluid connection with the reactor. A first pressure gauge is located downstream of the reactor, and a second pressure gauge is located upstream of the reactor. The pressure gauges can be used to monitor the pressure change across the reactor system. The transfer line is in fluid communication with the reactor and can be used to deliver the feedstock gas and the carrier gas to the reactor. The feedstock gas is introduced to the reactor at a velocity between about 5 to about 200 mL/min, for example about 10 to about 200 mL/min, about 20 to about 200 mL/min, about 40 to about 200 mL/min, about 80 to about 200 mL/min, or about 180 to about 200 mL/min. In some embodiments, the feedstock gas is introduced to the reactor at a velocity between about 5 to about 180 mL/min, for example from about 5 to about 170 mL/min, about 5 to about 160 mL/min, about 5 to about 150 mL/min, about 5 to about 140 mL/min, about 5 to about 130 mL/min, about 5 to about 120 mL/min, about 5 to about 110 mL/min, about 5 to about 100 mL/min, about 5 to about 90 mL/min, about 5 to about 80 mL/min, about 5 to about 70 mL/min, about 5 to about 60 mL/min, about 5 to about 50 mL/min, about 5 to about 40 mL/min, about 5 to about 30 mL/min, about 5 to about 20 mL/min, or about 5 to about 10 mL/min. The feedstock gas and the carrier gas are introduced to the reactor at a temperature of about 500° C. to about 900° C., for example about 550° C. to about 850° C., about 600° C. to about 800° C., about 650° C. to about 750° C., or about 700° C. The feedstock gas and the carrier gas can be heated with conventional heating, induction heating, radiative heating, or heating with renewable energy sources. After heating, the feedstock gas and carrier gas are directed into the reactor. The reactor includes a catalyst bed, where the catalyst bed includes a plurality of MEA catalysts as described herein. In some embodiments, the reactor is a fixed-bed flow reactor. In the reactor and in the presence of the catalysts including MEA particles, the methane in the feedstock gas undergoes rapid thermal cracking, producing solid carbon and hydrogen gas. Downstream of the reactor, the system includes a solid carbon collection unit. The solid carbon collection unit can be a stainless-steel container, or a unit that uses a cyclone action to collect solid carbon. Downstream of the solid carbon collection unit the system includes a filter and gas separation unit. In some embodiments, the filter and gas separation unit includes a filter. The filter can be a mesh screen that blocks carbon particles. In some embodiments, the filter and gas separation unit includes a membrane that separates hydrogen from unreacted methane gas. In some embodiments, the system includes an online analytical instrument downstream of the filter and gas separation unit. The analytical instrument can include, for example, on-line mass spectroscopy and/or on-line gas chromatography-thermal conductivity detector. The analytical instrument can be used to analyze unreacted methane, produced hydrogen gas, and any other possible byproducts or reactants.

Methane pyrolysis also produces a solid carbon byproduct. The solid carbon byproduct can be in the form of amorphous carbon, carbon nanotubes, or nanofibers, which have high market value.

### Hydrogen Production

The system described herein can be used to produce clean hydrogen with a solid carbon byproduct. The production of hydrogen can be carried out in a fixed-bed reactor system at atmospheric pressure. First, an MEA catalyst as described herein is loaded into the reactor. Next, the system is purged with an inert gas to remove oxygen in the reactor environment. In some embodiments, the inert gas is N₂. In some embodiments, the inert gas is introduced to the system at a rate of about 20 to about 200 mL/min, for example from for example about 20 to about 200 mL/min, about 30 to about 200 mL/min, about 40 to about 200 mL/min, about 50 to about 200 mL/min, about 60 to about 200 mL/min, about 60 to about 200 mL/min, about 70 to about 200 mL/min, about 80 to about 200 mL/min, about 90 to about 200 mL/min, about 100 to about 200 mL/min, about 100 to about 200 mL/min, about 110 to about 200 mL/min, about 120 to about 200 mL/min, about 130 to about 200 mL/min, about 140 to about 200 mL/min, about 150 to about 200 mL/min, about 160 to about 200 mL/min, about 170 to about 200 mL/min, about 180 to about 200 mL/min, or about 190 to about 200 mL/min. The applied velocity of the inert gas can depend on the amount of catalyst in the reactor. For example, the applied velocity can be increased for increased amounts of catalyst. Next, the reactor is heated to a temperature of about 500° C. to about 700° C., for example, about 510° C. to about 700° C., about 520° C. to about 700° C., about 530° C. to about 700° C., about 540° C. to about 700° C., about 550° C. to about 700° C., about 560° C. to about 700° C., about 570° C. to about 700° C., about 580° C. to about 700° C., about 590° C. to about 700° C., about 600° C. to about 700° C., about 610° C. to about 700° C., about 620° C. to about 700° C., about 630° C. to about 700° C., about 640° C. to about 700° C., about 650° C. to about 700° C., about 660° C. to about 700° C., about 670° C. to about 700° C., about 680° C. to about 700° C., about 690° C. to about 700° C., or about 700° C. In some embodiments, the temperature of the reactor is increased at a ramp rate of about 10° C./min to about 15° C./min, for example about 11° C./min to about 15° C., about 12° C./min to about 15° C./min, about 13° C./min to about 15° C./min, about 14° C./min to about 15° C./min, or about 15° C./min. Next, methane from the feedstock gas is introduced into the reactor. In some embodiments, the feedstock gas is introduced into the reactor at a rate of about 5 mL/min to about 200 mL/min, for example about 10 to about 200 mL/min, about 20 to about 200 mL/min, about 30 to about 200 mL/min, about 40 to about 200 mL/min, about 50 to about 200 mL/min, about 60 to about 200 mL/min, about 70 to about 200 mL/min, about 80 to about 200 mL/min, about 90 to about 200 mL/min, about 100 to about 200 mL/min, about 110 to about 200 mL/min, about 120 to about 200 mL/min, about 130 to about 200 mL/min, about 140 to about 200 mL/min, about 150 to about 200 mL/min, about 160 to about 200 mL/min, about 170 to about 200 mL/min, about 180 to about 200 mL/min, or about 190 to about 200 mL/min. In some embodiments, the feedstock gas is introduced to the reactor at a temperature between about 500° C. and about 900° C. at atmospheric pressure. For example, the feedstock can be introduced into the reactor at a temperature between about 510° C. and about 800° C., about 520° C. and about 800° C., about 530° C. and about 800° C., about 540° C. and about 800° C., about 550° C. and about 800° C., about 560° C. and about 800° C., about 560° C. and about 800° C., about 570° C. and about 800° C., about 580° C. and about 800° C., about 590° C. and about 800° C., about 600° C. and about 800° C., about 610° C. and about 800° C., about 620° C. and about 800° C., about 630° C. and about 800° C., about 640° C. and about 800° C., about 650° C. and about 800° C., about 660° C. and about 800° C., about 670° C. and about 800° C., about 680° C. and about 800° C., about 690° C. and about 800° C., about 700° C. and about 800° C., about 750° C. and about 800° C., about 760° C. and about 800° C., about 770° C. and about 800° C., about 780° C. and about 800° C., about 790° C. and about 800° C., about 600° C. and about 800° C., about 610° C. and about 790° C., about 620° C. and about 780° C., about 630° C. and about 770° C., about 640° C. and about 760° C., about 650° C. and about 750° C., about 660° C. and about 740° C., about 670° C. and about 730° C., about 680° C. and about 720° C., about 690° C. and about 710° C., or at about 700° C. Next, the pyrolysis of methane is catalyzed with the catalyst to produce hydrogen gas. In some embodiments, the gases produced by the methane pyrolysis reaction can be analyzed using an online analytical instrument, for example a gas-chromatography-thermal conductive detector. In some embodiments, the hydrogen produced in the methane pyrolysis reaction can be separated, for example, using a hydrogen separation membrane. In some embodiments the solid carbon produced by the methane pyrolysis reaction can be collected using a solid carbon collection unit.

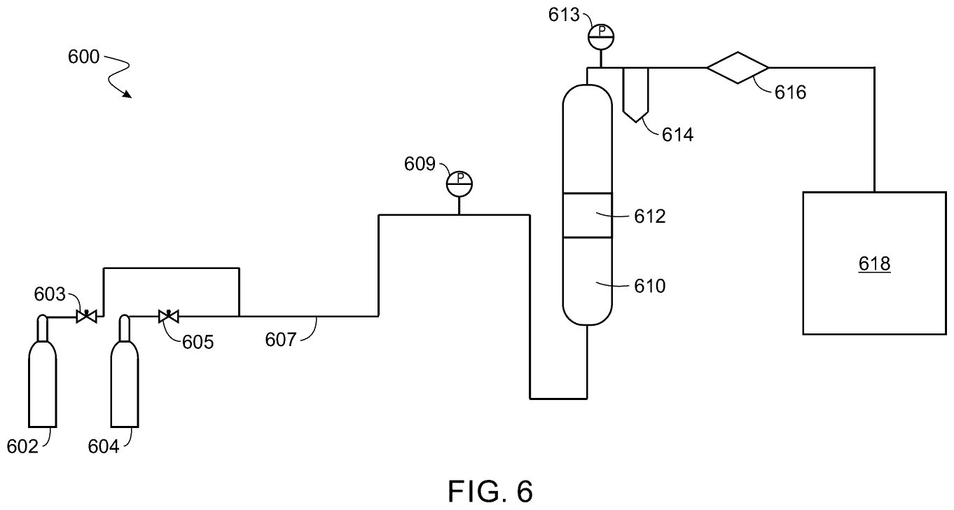

FIG. 6 shows an example schematic of a fixed-bed flow reactor system 600. The system includes a carrier gas source 602 and a carrier gas valve 603. The system includes a feedstock gas source 604 and a feedstock gas valve 605. In some implementations, the carrier gas is N₂ or Ar. The system includes a transfer line 607. The carrier gas source 602 is in fluid communication with the transfer line 607 via the carrier gas valve 603. The feedstock gas source 604 is in fluid communication with the transfer line 607 via the feedstock gas valve 605. The transfer line is configured and coupled to deliver the feedstock gas and/or carrier gas to a reactor 610. The system includes a reactor 610 including a catalyst bed 612. The catalyst bed 612 includes MEA catalysts as described herein. The system includes a first pressure gauge 609 installed upstream of the reactor 610 and a second pressure gauge 613 installed downstream of the reactor 610. The pressure gauges can be used to monitor the pressure change across the reactor system. The system includes a solid carbon collection unit 614. In some embodiments, the carbon collection unit is a stainless-steel container. In some embodiments, the carbon collection unit uses a cyclone action to collect solid carbon. The system includes a filter and gas separation unit 616. In some embodiments, the filter and gas separation unit includes a filter. The filter can be a mesh screen that blocks carbon particles. In some embodiments, the filter and gas separation unit includes a membrane that separates hydrogen from unreacted methane gas. In some embodiments, the system includes an online analytical instrument 618. The analytical instrument can be used to monitor the reaction progress and amount of hydrogen gas produced. In some embodiments, the online analytical instrument is a mass spectrometer and/or gas chromatography instrument, for example a gas chromatography-thermal conductivity detector.

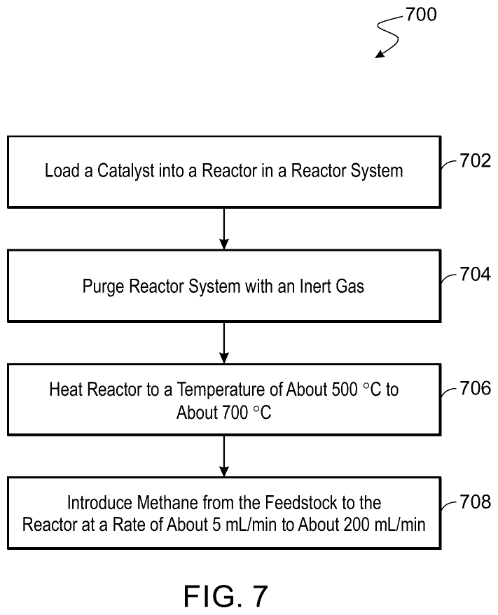

FIG. 7 is a flow chart of an example method of producing hydrogen and a solid carbon byproduct. At 702, an MEA catalyst as described herein is loaded into the reactor of a reactor system. At 704, the system is purged with an inert gas to remove oxygen in the reactor environment. In some embodiments, the inert gas is N₂. In some embodiments, the inert gas is introduced to the system at a rate of about 20 to about 200 mL/min, for example from for example about 30 to about 200 mL/min, about 40 to about 200 mL/min, about 50 to about 200 mL/min, about 60 to about 200 mL/min, about 60 to about 200 mL/min, about 70 to about 200 mL/min, about 80 to about 200 mL/min, about 90 to about 200 mL/min, about 100 to about 200 mL/min, about 100 to about 200 mL/min, about 110 to about 200 mL/min, about 120 to about 200 mL/min, about 130 to about 200 mL/min, about 140 to about 200 mL/min, about 150 to about 200 mL/min, about 160 to about 200 mL/min, about 170 to about 200 mL/min, about 180 to about 200 mL/min, or about 190 to about 200 mL/min. The applied velocity of the inert gas can depend on the amount of catalyst in the reactor. For example, the applied velocity can be increased for increased amounts of catalyst. At 706, the reactor is heated to a temperature of about 500° C. to about 700° C., for example, 510° C. and about 800° C., about 520° C. and about 800° C., about 530° C. and about 800° C., about 540° C. and about 800° C., about 550° C. and about 800° C., about 560° C. and about 800° C., about 560° C. and about 800° C., about 570° C. and about 800° C., about 580° C. and about 800° C., about 590° C. and about 800° C., about 600° C. and about 800° C., about 610° C. and about 800° C., about 620° C. and about 800° C., about 630° C. and about 800° C., about 640° C. and about 800° C., about 650° C. and about 800° C., about 660° C. and about 800° C., about 670° C. and about 800° C., about 680° C. and about 800° C., about 690° C. and about 800° C., about 700° C. and about 800° C., about 750° C. and about 800° C., about 760° C. and about 800° C., about 770° C. and about 800° C., about 780° C. and about 800° C., about 790° C. and about 800° C., about 600° C. and about 800° C., about 610° C. and about 790° C., about 620° C. and about 780° C., about 630° C. and about 770° C., about 640° C. and about 760° C., about 650° C. and about 750° C., about 660° C. and about 740° C., about 670° C. and about 730° C., about 680° C. and about 720° C., about 690° C. and about 710° C., or at about 700° C. In some embodiments, the temperature of the reactor is increased at a ramp rate of about 10° C./min to about 15° C./min, for example about 11° C./min to about 15° C., about 12° C./min to about 15° C./min, about 13° C./min to about 15° C./min, about 14° C./min to about 15° C./min, or about 15° C./min. At 708, the feedstock gas including methane is introduced into the reactor at a rate of about 5 mL/min to about 200 mL/min, for example about 10 to about 200 mL/min, about 20 to about 200 mL/min, about 30 to about 200 mL/min, about 40 to about 200 mL/min, about 50 to about 200 mL/min, about 60 to about 200 mL/min, about 70 to about 200 mL/min, about 80 to about 200 mL/min, about 90 to about 200 mL/min, about 100 to about 200 mL/min, about 110 to about 200 mL/min, about 120 to about 200 mL/min, about 130 to about 200 mL/min, about 140 to about 200 mL/min, about 150 to about 200 mL/min, about 160 to about 200 mL/min, about 170 to about 200 mL/min, about 180 to about 200 mL/min, or about 190 to about 200 mL/min. At 710, the pyrolysis of methane is catalyzed using the MEA catalyst. In some embodiments, the produced hydrogen gas is analyzed with an online line analytical instrument.

### Definitions

The term “about” as used in this disclosure can allow for a degree of variability in a value or range, for example, within 10%, within 5%, or within 1% of a stated value or of a stated limit of a range.

The term “room temperature” as used in this disclosure refers to a temperature of about 15 degrees Celsius (C) to about 28° C.

As used in this disclosure, “weight percent” (wt %) can be considered a mass fraction or a mass ratio of a substance to the total mixture or composition. Weight percent can be a weight-to-weight ratio or mass-to-mass ratio, unless indicated otherwise.

As used in this disclosure, “atomic percent” (at %) can be considered an atomic fraction or atomic ratio of a substance to the total mixture or composition. Atomic percent can be an atom-to-atom ratio or mole-to-mole ratio, unless indicated otherwise.

A number of embodiments of the disclosure have been described. Nevertheless, it will be understood that various modifications may be made without departing from the spirit and scope of the disclosure.

### EMBODIMENTS

1. A catalyst comprising:
a medium entropy alloy (MEA) particle, wherein the MEA particle comprises
   a first principal metal,
   a second principal metal, and
   a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.
2. The catalyst of embodiment 1, wherein one of the first principal metal, the second principal metal, or the third principal metal is present in the MEA particle at 30 atomic percent (at %) or more.
3. The catalyst of embodiment 1 or 2, wherein the MEA particle includes a promoter, wherein the promoter is selected from the group consisting of molybdenum, calcium, cesium, In₂O₃, Cr₂O₃, and rare earth metals, and any combination thereof.
4. The catalyst of embodiment 3, wherein the atomic percentage (at %) of the promoter in the MEA particle is from about 0.5 at % to about 10 at %.
5. The catalyst of any one of embodiments 1-4, wherein the MEA particle further comprises a non-reducible metal oxide selected from the group consisting of Li₂O, K₂O, Na₂O, Cs₂O, BeO, MgO, CaO, SrO, BaO, P₂O₅, A1₂O₃, Al₂O₄, In₂O₃, SiO₂, TiO₂, ZrO₂, CeO₂, Y₂O₃, La₂O₃, and Er₂O₃, and any combination thereof.
6. The catalyst of embodiment 5, wherein the atomic percentage (at %) of the non-reducible metal oxide in the MEA particle is less than about 20 at %.
7. The catalyst of any one of embodiments 1-6, wherein the catalyst includes a metal chloride selected from the group consisting of metal chlorides of Li, Na, Ca, K, Cs, or Fr, or chlorides of Fe, Co, Mn, Mg, Al, Ni, Mo, Cu, Pd, Pt, Ce, Mg, La, Nd, Ge, and Re, and any combination thereof.
8. The catalyst of embodiment 7, wherein the atomic percentage (at %) of the metal chloride in the MEA particle is less than about 20 at %.
9. The catalyst of any one of embodiments 1-8, wherein the MEA particle further comprises a non-reducible and high-temperature-stable compound selected from the group consisting of carbides, borides, boron carbides, nitrides, boron nitrides, silicide, aluminides, phosphides, phosphates, sulfides, sulfates, hydrides, hydrates, carbonitrides, graphene, graphene oxide, carbon nanotubes, graphite, and any combinations thereof.
10. The catalyst of embodiment 9, wherein the non-reducible and high-temperature-stable is selected from the group consisting of Fe₃C, KBr, NaNO₃, B₄C, BN, Na₄Si₄, Na₂Al₂O₄, FeP, Na₃PO₄, FeS, Na₂SO₄, MgH₂, and C₃N₄, and any combination thereof.
11. The catalyst of embodiment 9 or 10, wherein the atomic percentage (at %) of the non-reducible and high-temperature-stable compound in the MEA particle is less than about 20 at %.
12. The catalyst of any one of embodiments 1-11, wherein the MEA particle is from about 1 nm to about 10 um in diameter.
13. The catalyst of any one of embodiments 1-12, wherein the MEA particle further comprises a fourth principal metal, wherein the fourth principal metal is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.
14. The catalyst of embodiment 13, wherein one of the first principal metal, the second principal metal, the third principal metal, or the fourth principal metal is present in the MEA particle at 30 atomic percent (at %) or more.
15. The catalyst of embodiment 13 or 14, wherein the MEA particle includes a promoter, wherein the promoter is selected from the group consisting of molybdenum, calcium, cesium, In₂O₃, Cr₂O₃, and rare earth metals, and any combination thereof.
16. The catalyst of embodiment 15, wherein the atomic percentage (at %) of the promoter in the MEA particle is from about 0.5 at % to about 10 at %.
17. The catalyst of any one of embodiments 13-16, wherein the MEA particle further comprises a non-reducible metal oxide selected from the group consisting of Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, La₂O₃, and Er₂O₃, and any combination thereof.
18. The catalyst of embodiment 17, wherein the atomic percentage (at %) of the non-reducible metal oxide in the MEA particle is less than about 20 at %.
19. The catalyst of any one of embodiments 13-18, wherein the catalyst includes a metal chloride selected from the group consisting of metal chlorides of Li, Na, Ca, K, Cs, or Fr, or chlorides of Fe, Co, Mn, Mg, Al, Ni, Mo, Cu, Pd, Pt, Ce, Mg, La, Nd, Ge, and Re, and any combination thereof.
20. The catalyst of embodiment 19, wherein the atomic percentage (at %) of the metal chloride in the MEA particle is less than about 20 at %.
21. The catalyst of any one of embodiments 13-20, wherein the MEA particle further comprises a non-reducible and high-temperature-stable compound selected from the group consisting of carbides, borides, boron carbides, nitrides, boron nitrides, silicide, aluminides, phosphides, phosphates, sulfides, sulfates, hydrides, hydrates, carbonitrides, graphene, graphene oxide, carbon nanotubes, graphite, and any combinations thereof.
22. The catalyst of embodiment 21, wherein the non-reducible and high-temperature-stable compound is selected from the group consisting of Fe₃C, KBr, NaNO₃, B₄C, BN, Na₄Si₄, Na₂Al₂O₄, FeP, Na₃PO₄, FeS, Na₂SO₄, MgH₂, and C₃N₄, and any combination thereof.
23. The catalyst of embodiment 21 or 22, wherein the atomic percentage (at %) of the non-reducible and high-temperature-stable compound in the MEA particle is less than about 20 at %.
24. The catalyst of any one of embodiments 13-23, wherein the MEA particle is from about 1 nm to about 10 μm in diameter.
25. A method of producing a catalyst, the method comprising:

placing a first principal metal, a second principal metal, and a third principal metal, and zirconia media in a ball mill, wherein each of the principal metals is independently selected without repetition from the group consisting Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be;
rotating the ball mill to produce the catalyst; and
separating the produced catalyst from the zirconia media.
26. The method of embodiment 25, further comprising placing a fourth principal metal in the ball mill before rotating the ball mill, wherein the fourth principal metal is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.
27. The method of embodiment 25 or 26, wherein the ball mill is rotated for about 2 days at about 1100 rpm.
28. The method of any one of embodiments 25-27, further comprising placing a non-reducible metal oxide in the ball mill before rotating the ball mill, wherein the non-reducible metal oxide is selected from the group consisting of Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, La₂O₃, and Er₂O₃, and any combination thereof.
29. The method of any one of embodiments 25-28, further comprising placing a metal chloride in the ball mill before rotating the ball mill, wherein the metal chloride is selected from the group consisting of metal chlorides of Li, Na, Ca, K, Cs, or Fr, or chlorides of Fe, Co, Mn, Mg, Al, Ni, Mo, Cu, Pd, Pt, Ce, Mg, La, Nd, Ge, and Re, and any combination thereof.
30. The method of any one of embodiments 25-29, wherein the zirconia media comprises zirconia particles with a diameter of about 1 mm and zirconia particles with a diameter of about 3 mm.
31. A method of catalyzing methane pyrolysis, the method comprising:
loading a catalyst into a reactor, wherein the catalyst comprises
   a medium entropy alloy (MEA) particle, wherein the MEA particle comprises
      a first principal metal,
      a second principal metal, and
   a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be;
purging the reactor with an inert gas;
heating the reactor;
introducing a feedstock gas and a carrier gas to the reactor, wherein the feedstock gas comprises methane and wherein the carrier gas comprises an inert gas; and
catalyzing the pyrolysis of the methane using the catalyst to produce hydrogen gas and solid carbon.
32. The method of embodiment 31, wherein the MEA particle further comprises a fourth principal metal, wherein the fourth principal metal is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.
33. The method of embodiment 31 or 32, wherein the MEA particle further comprises a non-reducible metal oxide selected from the group consisting of Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, La₂O₃, and Er₂O₃, , and any combination thereof.
34. The method of any one of embodiments 31-33, wherein the MEA particle further comprises a metal chloride selected from the group consisting of metal chlorides of Li, Na, Ca, K, Cs, or Fr, or chlorides of Fe, Co, Mn, Mg, Al, Ni, Mo, Cu, Pd, Pt, Ce, Mg, La, Nd, Ge, and Re, and any combination thereof.
35. The method of any one of embodiments 31-34, wherein purging the reactor with an inert gas comprises purging the reactor with N₂ gas.
36. The method of any one of embodiments 31-35, wherein purging the reactor with an inert gas comprises introducing the inert gas to the reactor at a rate of about 20 to about 200 mL/min.
37. The method of any one of embodiments 31-36, wherein heating the reactor comprises heating the reactor to a temperature of about 500° C. to about 700° C.
38. The method of any one of embodiments 31-37, wherein heating the reactor comprises increasing the temperature of the reactor at a ramp rate of about 10° C./min to about 15° C./min.
39. The method of any one of embodiments 31-38, wherein the feedstock gas comprises natural gas.
40. The method of any one of embodiments 31-39, wherein the carrier gas comprises N₂, Ar, or a combination thereof.
41. The method of any one of embodiments 31-40, wherein the feedstock gas is introduced into the reactor at a velocity of between about 5 mL/min to about 200 mL/min.
42. The method of any one of embodiments 31-41, wherein the feedstock gas is introduced to the reactor at a temperature between about 500° C. and about 900° C.
43. The method of any one of embodiments 31-42, wherein the feedstock gas is introduced to the reactor at atmospheric pressure.
44. The method of any one of embodiments 31-43, further comprising analyzing the gases produced by the methane pyrolysis using online gas-chromatography equipped with a thermal conductive detector.
45. The method of any one of embodiments 31-44, further comprising separating the produced hydrogen gas using a hydrogen separation membrane.
46. The method of any one of embodiments 31-45, further comprising collecting the produced solid carbon using a solid carbon collection unit.

What is claimed is:

1. A catalyst comprising:
a medium entropy alloy (MEA) particle, wherein the MEA particle comprises
a first principal metal,
a second principal metal, and
a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.

2. The catalyst of claim 1, wherein one of the first principal metal, the second principal metal, or the third principal metal is present in the MEA particle at 30 atomic percent (at %) or more.

3. The catalyst of claim 1, wherein the MEA particle includes a promoter, wherein the promoter is selected from the group consisting of molybdenum, calcium, cesium, In₂O₃, Cr₂O₃, and rare earth metals, and any combination thereof.

4. The catalyst of claim 3, wherein the atomic percentage (at %) of the promoter in the MEA particle is from about 0.5 at % to about 10 at %.

5. The catalyst of claim 1, wherein the MEA particle further comprises a non-reducible metal oxide selected from the group consisting of Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, La₂O₃, and Er₂O₃, and any combination thereof.

6. The catalyst of claim 5, wherein the atomic percentage (at %) of the non-reducible metal oxide in the MEA particle is less than about 20 at %.

7. The catalyst of claim 1, wherein the catalyst includes a metal chloride selected from the group consisting of metal chlorides of Li, Na, Ca, K, Cs, or Fr, or chlorides of Fe, Co, Mn, Mg, Al, Ni, Mo, Cu, Pd, Pt, Ce, Mg, La, Nd, Ge, and Re, and any combination thereof.

8. The catalyst of claim 7, wherein the atomic percentage (at %) of the metal chloride in the MEA particle is less than about 20 at %.

9. The catalyst of claim 1, wherein the MEA particle further comprises a non-reducible and high-temperature-stable compound selected from the group consisting of carbides, borides, boron carbides, nitrides, boron nitrides, silicide, aluminides, phosphides, phosphates, sulfides, sulfates, hydrides, hydrates, carbonitrides, graphene, graphene oxide, carbon nanotubes, graphite, and any combinations thereof.

10. The catalyst of claim 9, wherein the non-reducible and high-temperature-stable compound is selected from the group consisting of Fe₃C, KBr, NaNO₃, B₄C, BN, Na₄Si₄, Na₂Al₂O₄, FeP, Na₃PO₄, FeS, Na₂SO₄, MgH₂, and C₃N₄, and any combination thereof.

11. The catalyst of claim 9, wherein the atomic percentage (at %) of the non-reducible and high-temperature-stable compound in the MEA particle is less than about 20 at %.

12. The catalyst of claim 1, wherein the MEA particle is from about 1 nm to about 10 μm in diameter.

13. The catalyst of claim 1, wherein the MEA particle further comprises a fourth principal metal, wherein the fourth principal metal is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.

14. The catalyst of claim 13, wherein one of the first principal metal, the second principal metal, the third principal metal, or the fourth principal metal is present in the MEA particle at 30 atomic percent (at %) or more.

15. The catalyst of claim 13, wherein the MEA particle includes a promoter, wherein the promoter is selected from the group consisting of molybdenum, calcium, cesium, In₂O₃, Cr₂O₃, and rare earth metals, and any combination thereof.

16. The catalyst of claim 15, wherein the atomic percentage (at %) of the promoter in the MEA particle is from about 0.5 at % to about 10 at %.

17. The catalyst of claim 13, wherein the MEA particle further comprises a non-reducible metal oxide selected from the group consisting of Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, La₂O₃, and Er₂O₃, and any combination thereof.

18. The catalyst of claim 17, wherein the atomic percentage (at %) of the non-reducible metal oxide in the MEA particle is less than about 20 at %.

19. The catalyst of claim 13, wherein the catalyst includes a metal chloride selected from the group consisting of metal chlorides of Li, Na, Ca, K, Cs, or Fr, or chlorides of Fe, Co, Mn, Mg, Al, Ni, Mo, Cu, Pd, Pt, Ce, Mg, La, Nd, Ge, and Re, and any combination thereof.

20. The catalyst of claim 19, wherein the atomic percentage (at %) of the metal chloride in the MEA particle is less than about 20 at %.

21. The catalyst of claim 13, wherein the MEA particle further comprises a non-reducible and high-temperature-stable compound selected from the group consisting of carbides, borides, boron carbides, nitrides, boron nitrides, silicide, aluminides, phosphides, phosphates, sulfides, sulfates, hydrides, hydrates, carbonitrides, graphene, graphene oxide, carbon nanotubes, graphite, and any combinations thereof.

22. The catalyst of claim 21, wherein the non-reducible and high-temperature-stable compound is selected from the group consisting of Fe₃C, KBr, NaNO₃, B₄C, BN, Na₄Si₄, Na₂Al₂O₄, FeP, Na₃PO₄, FeS, Na₂SO₄, MgH₂, and C₃N₄, and any combination thereof.

23. The catalyst of claim 21, wherein the atomic percentage (at %) of the non-reducible and high-temperature-stable compound in the MEA particle is less than about 20 at %.

24. The catalyst of claim 13, wherein the MEA particle is from about 1 nm to about 10 μm in diameter.

25. A method of producing a catalyst, the method comprising:
placing a first principal metal, a second principal metal, and a third principal metal, and zirconia media in a ball mill, wherein each of the principal metals is independently selected without repetition from the group consisting Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be;
rotating the ball mill to produce the catalyst; and
separating the produced catalyst from the zirconia media.

26. The method of claim 25, further comprising placing a fourth principal metal in the ball mill before rotating the ball mill, wherein the fourth principal metal is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.

27. The method of claim 25, wherein the ball mill is rotated for about 2 days at about 1100 rpm.

28. The method of claim 25, further comprising placing a non-reducible metal oxide in the ball mill before rotating the ball mill, wherein the non-reducible metal oxide is selected from the group consisting of Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, La₂O₃, and Er₂O₃, and any combination thereof.

29. The method of claim 25, further comprising placing a metal chloride in the ball mill before rotating the ball mill, wherein the metal chloride is selected from the group consisting of metal chlorides of Li, Na, Ca, K, Cs, or Fr, or chlorides of Fe, Co, Mn, Mg, Al, Ni, Mo, Cu, Pd, Pt, Ce, Mg, La, Nd, Ge, and Re, and any combination thereof.

30. The method of claim 25, wherein the zirconia media comprises zirconia particles with a diameter of about 1 mm and zirconia particles with a diameter of about 3 mm.

31. A method of catalyzing methane pyrolysis, the method comprising:
loading a catalyst into a reactor, wherein the catalyst comprises
a medium entropy alloy (MEA) particle, wherein the MEA particle comprises
a first principal metal,
a second principal metal, and
a third principal metal, wherein each of the principal metals is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be;
purging the reactor with an inert gas;
heating the reactor;
introducing a feedstock gas and a carrier gas to the reactor, wherein the feedstock gas comprises methane and wherein the carrier gas comprises an inert gas; and
catalyzing the pyrolysis of the methane using the catalyst to produce hydrogen gas and solid carbon.

32. The method of claim 31, wherein the MEA particle further comprises a fourth principal metal, wherein the fourth principal metal is independently selected without repetition from the group consisting of Co, Cr, Fe, Mn, Ni, Al, Cu, Zn, Ti, Zr, Mo, V, Ru, Rh, Pd, Ag, W, Re, Ir, Pt, Au, Ce, Y, Yb, Sn, Ga, In, and Be.

33. The method of claim 31, wherein the MEA particle further comprises a non-reducible metal oxide selected from the group consisting of Li₂O, K₂O, Na₂O, Cs₂O, BeO, MgO, CaO, SrO, BaO, P₂O₅, Al₂O₃, Al₂O₄, In₂O₃, SiO₂, TiO₂, ZrO₂, CeO₂, Y₂O₃, La₂O₃, and Er₂O₃, and any combination thereof.

34. The method of claim 31, wherein the MEA particle further comprises a metal chloride selected from the group consisting of metal chlorides of Li, Na, Ca, K, Cs, or Fr, or chlorides of Fe, Co, Mn, Mg, Al, Ni, Mo, Cu, Pd, Pt, Ce, Mg, La, Nd, Ge, and Re, and any combination thereof.

35. The method of claim 31, wherein purging the reactor with an inert gas comprises purging the reactor with N₂ gas.

36. The method of claim 31, wherein purging the reactor with an inert gas comprises introducing the inert gas to the reactor at a rate of about 20 to about 200 mL/min.

37. The method of claim 31, wherein heating the reactor comprises heating the reactor to a temperature of about 500° C. to about 700° C.

38. The method of claim 31, wherein heating the reactor comprises increasing the temperature of the reactor at a ramp rate of about 10° C./min to about 15° C./min.

39. The method of claim 31, wherein the feedstock gas comprises natural gas.

40. The method of claim 31, wherein the carrier gas comprises N₂, Ar, or a combination thereof.

41. The method of claim 31, wherein the feedstock gas is introduced into the reactor at a velocity of between about 5 mL/min to about 200 mL/min.

42. The method of claim 31, wherein the feedstock gas is introduced to the reactor at a temperature between about 500° C. and about 900° C.

43. The method of claim 31, wherein the feedstock gas is introduced to the reactor at atmospheric pressure.

44. The method of claim 31, further comprising analyzing the gases produced by the methane pyrolysis using online gas-chromatography equipped with a thermal conductive detector.

45. The method of claim 31, further comprising separating the produced hydrogen gas using a hydrogen separation membrane.

46. The method of claim 31, further comprising collecting the produced solid carbon using a solid carbon collection unit.
